(19) United States
(12) Patent Application Publication
(10) Pub. No.: US 2005/0201533 A1
(43) Pub. Date: Sep. 15, 2005

(54) Dynamic call processing system and method

(76) Inventors: Sean Afshin Emam, Woodinville, WA (US); Anh Tuan Truong, Redmond, WA (US); Robert R. O'Brien, Kirkland, WA (US); Praveen Seshadri, Bellevue, WA (US); John T. Wilcox, Redmond, WA (US)

Correspondence Address: AMIN & TUROCY, LLP, 24TH FLOOR, NATIONAL CITY CENTER, 1900 EAST NINTH STREET, CLEVELAND, OH, 44114, US

(21) Appl. No.: 10/797,273

(22) Filed: Mar. 10, 2004

(51) Int. Cl. H04M 11/00; H04M 1/64

(52) U.S. Cl. 379/88.19; 379/88.16

(57) ABSTRACT

The present invention relates to a dynamic response telecommunication system and method. The present dynamic response system marries client, server and services with telecommunication service provider's back-end to provide a richer customer experience in place of or in combination with static voice answering or messaging. The present invention enables dynamic creation of a response to an incoming telephone call based on evaluation of a calling party's credentials against local information and call rules stored on a user's computer system or device or alternatively cached at the service provider. The result can be a dynamic response message, locale and announcer information for prompt playback in a specific language as well as action options for further call processing.

### TECHNICAL FIELD

The present invention relates generally to computers and more particularly toward dynamic telephonic call processing.

### BACKGROUND

Telecommunication companies provide subscribing customers with such services as voice mail. Conventional voice mail systems receive a call after a predetermined number of rings and play a prerecorded static message to the caller such as “I am unavailable right now, please leave your name and number and I will call you back.” A beep is then sounded and the system records a caller's message. The called party can then be notified when a message has been recorded for them to review. For example, some systems flicker the dial tone sound when the phone is picked up. Other systems produce a sound and/or flash a light (e.g., LED). The called party/voice mail client can then retrieve the recorded messages from a central storage location by calling a particular number. The client may then be required to enter a password. Subsequently, a prerecorded canned message is played for a user indicting the number of messages addressed to them followed by some instructions regarding how to play, fast forward, rewind, delete and/or save messages. Voice mail clients can then use a phone to listen to their recorded messages. More advanced voice mails systems can utilize mail boxes to support multiple users. Individual users of the same voice mail system can utilize a phone to setup personal mailboxes to house their messages. Subsequently, callers can record messages and place them into particular mailboxes utilizing a telephone key pad. For example, a person calls and hears a canned message followed by options such as if you would like to leave a message for Bill press one, for Mary press two, etc.

Call forwarding is also a conventionally provided service by a telecommunication company. Once activated this service allows a users to have calls forwarded from one telephone number to another. Call forwarding is useful for people how spend a lot of time away from home. In such a scenario, users can contact the phone company and have any calls to their home phone number transferred to their mobile phone, for example. Some flexible systems allow calls to be forwarded after a certain number of rings or upon receipt of a busy signal to allow users to retrieve calls at the originally dialed number first prior to forwarding to a secondary number.

In any event, conventional telephonic call services are limited and static in nature. Accordingly, there is a need in the art for a dynamic call response system that enables users to easily personalize or customize responses to incoming calls.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention is directed toward a system and method for dynamically processing incoming calls and generating customized messages for particular callers or groups of callers. According to one aspect of the present invention a switch receives a call and provides a client computer system or device with caller identification information. The caller identification information is utilized in conjunction with other variables such as the status and/or location of the called person or entity to execute call preferences or rules specified by a called person to generate customized messages.

According to an aspect of the invention, client call preferences or rules contain conditional statements and actions thereon (e.g., if-then statements). For example, if the caller is an important client and I am in a meeting then generate a message indicating that I will call the client back sometime after I get out of the meeting. Call preferences can be stored on a local client device store. Additionally or alternatively, call preferences can be cached on a service provider's local store to facilitate expeditious generation of messages upon the arrival of a call.

According to another aspect of the invention the generated response messages can be translated from a first language to a second language utilizing a translation component and one or more dictionary components.

According to yet another aspect of the subject invention, called parties or entities can receive notifications upon receipt of a call from a particular person. For example, if an important client, as defined in the preferences, calls then notification can be provided to the called party via any one of a plurality of devices such as a pager, a phone (e.g., mobile, home, office), a personal digital assistant (PDA), or a computer (e.g., via email, instant message . . . ). Furthermore, if a preference does not specify a particular manner of notification, an appropriate device and method can be inferred utilizing a context component and an inferential engine.

In brief, the present invention integrates client, server and service properties with telecommunication service provider's back-end to provide a richer customer experience in place of the conventional static voice answering and messaging. Dynamic creation of a response to an incoming call based at least in part upon the validation of a caller's credentials (e.g., name, phone number . . . ) against local information on a user's active computing device or cached at a service provider significantly improves customers' experience with voice messaging. Furthermore, according to one aspect of the subject invention, customer/subscriber ease of use is facilitated by pushing decision logic and/or the manner of specifying such logic down to a local consumer device such as a personal computer.

To the accomplishment of the foregoing and related ends, certain illustrative aspects of the invention are described herein in connection with the following description and the annexed drawings. These aspects are indicative of various ways in which the invention may be practiced, all of which are intended to be covered by the present invention. Other advantages and novel features of the invention may become apparent from the following detailed description of the invention when considered in conjunction with the drawings.

### BRIEF DESCRIPTION OF THE DRAWINGS

The foregoing and other aspects of the invention will become apparent from the following detailed description and the appended drawings described in brief hereinafter.

FIG. 1 is a schematic block diagram of an interactive user message system in accordance with an aspect of the present invention.

FIG. 2 is a schematic block diagram of a client computer system in accordance with an aspect of the subject invention.

FIG. 3 is a schematic block diagram of a call processing component in accordance with an aspect of the subject invention.

FIG. 4 is an exemplary graphical user interface that can be employed in accordance with an aspect of the present invention.

FIG. 5 is a schematic block diagram of a message translation system in accordance with an aspect of the subject invention.

FIG. 6 is a schematic block diagram of a context measurement system in accordance with an aspect of the present invention.

FIG. 7 is a block diagram of a hierarchical set of rules in accordance with an aspect of the subject invention.

FIG. 8 is a schematic block diagram of a context inference system in accordance with an aspect of the present invention.

FIG. 9 is block diagram of an exemplary call processing system to facilitate understanding of various aspects of the subject invention.

FIG. 10 is a flow chart diagram of a call processing methodology in accordance with an aspect of the present invention.

FIG. 11 is a flow chart diagram of method for customizing call responses in accordance with an aspect of the subject invention.

FIG. 12 is a flow chart diagram of a customized call processing methodology in accordance with an aspect of the present invention.

FIG. 13 is a schematic block diagram illustrating a suitable operating environment in accordance with an aspect of the present invention.

FIG. 14 is a schematic block diagram of a sample-computing environment with which the present invention can interact.

### DETAILED DESCRIPTION

The present invention is now described with reference to the annexed drawings, wherein like numerals refer to like elements throughout. It should be understood, however, that the drawings and detailed description thereto are not intended to limit the invention to the particular form disclosed. Rather, the intention is to cover all modifications, equivalents, and alternatives falling within the spirit and scope of the present invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Furthermore, the present invention may be implemented as a method, apparatus, or article of manufacture using standard programming and/or engineering techniques to produce software, firmware, hardware, or any combination thereof. The term “article of manufacture” (or alternatively, “computer program product”) as used herein is intended to encompass a computer program accessible from any computer-readable device, carrier, or media. Of course, those skilled in the art will recognize many modifications may be made to this configuration without departing from the scope or spirit of the subject invention.

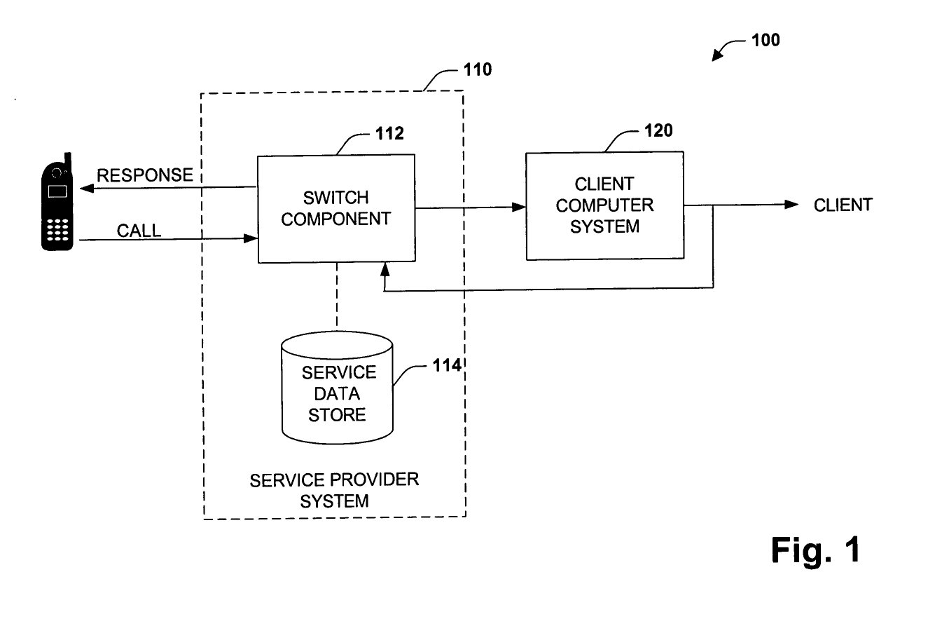

Turning to FIG. 1, a call processing system 100 is depicted in accordance with an aspect of the subject invention. Call processing system 100 provides dynamic and customized messages to a calling party when the called party is unavailable to take a call (e.g., in a meeting, out of the office, on vacation, presently talking on the phone . . . ). Call processing system 100 comprises a switch component 112, a service data store 114, and a client computer system 120. Switch component 112 and service data store 114 are associated with a service provider system 110. Switch component 112 receives telephonic calls from a multitude of calling parties (e.g., via mobile phone, land line . . . ). Switch component 112 can also provide voice messages (viz., computer voice, recorded human voice) to calling parties, connect calling parties to conventional voice mail or forward calling parties to a different number than was dialed. According to one aspect of the invention the switch component can be a private branch exchange (PBX) in a public switched telephone network (PSTN). Upon receipt of a call, the switch component quickly determines, for instance by utilizing a mapping or table stored in data store 114, whether the called party is a subscriber of enhanced services including the functionality provided by the combined call processing system 100. If the called party is not a subscriber then the call can be processed as usual, such as by routing the calling party to standard voice mail, continuing to ring, or returning a busy signal. If the called party is a subscriber, then the switch component can park the call and provide caller identification information to computer system 120. Parking a call can include notifying the user that the called party is being located or simulating a ring tone while the call is processed by a client computer system 120. Thus, decision logic can be pushed down to a client device or computer system for personalized response if so desired. Client computer system 120 can include any computer system as is described in more detail in the sections infra. For example, client computer system can include but is not limited to a personal computer (e.g., desktop or laptop), a video gaming system or console (e.g., Xbox®, Sony PlayStation®, Nintendo Game Cube® . . . ), a television set-top box, and a personal computing device (e.g., personal digital assistant (PDA), mobile phone, pocket PC, mobile to mobile IP device . . . ). Caller identification information can be provided to the client computer system 120 utilizing frequency shift keying techniques (FSK) and other techniques as are known in the art. Upon receiving caller identification information from a switch component 112, computer system 120 can apply one or more rules or user preferences to determine how to respond to the incoming call. Responses can be sent back to the calling party utilizing switch component 112. Furthermore, responses can be provided to other parties, such as the called party. Responses can include but are not limited to generating a personalized message to be transmitted back to the calling party, forwarding the calling party to voice mail, and notifying the called party of the call.

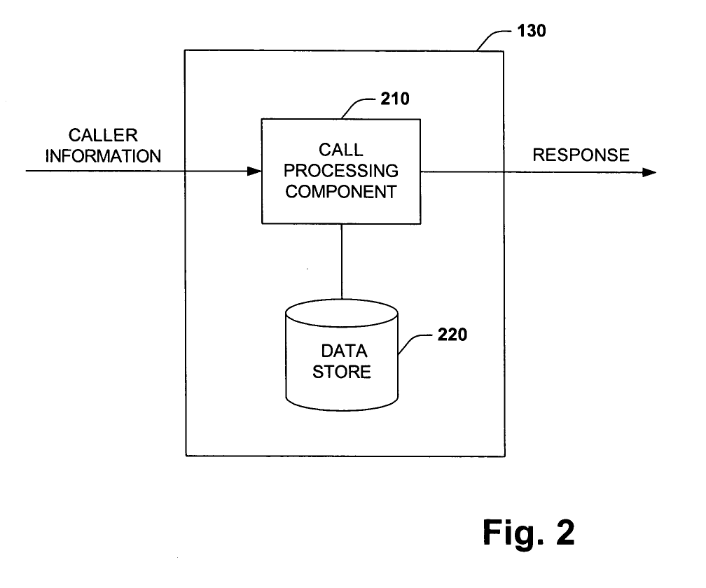

Turning to FIG. 2, a client computer system 120 is illustrated in further detail in accordance with an aspect of the subject invention. Client computer system 120 includes, inter alia, a call processing component 210 and a data store 220. Call processing component 210 is adapted to receive caller information. Caller information can include a calling party's name and/or phone number, if known. Caller information can also indicate that the calling party's information is unavailable or has been blocked by the calling party. Caller information can be received by a client computer system call response component 210 in a myriad of ways. For example, the client computer system 120 can be connected to a network using a modem (e.g., telephone, cable, power) that can facilitate receipt and transmission of information to and from a switch component 112 (FIG. 1). According to one aspect of the subject invention, call information can be provided to a personal computer via an instant message (IM) channel or similar technology. Instant messaging is a unique means of communication in which a user can transmit and receive information directly from another designated computer in real time. The technology utilizes a server that stores and transmits information regarding users' IP addresses and the number of the port they designate for communication purposes. Accordingly, if A wants to chat with B then the server provides A with B's IP address and port number and B with A's IP address and port number. The users can then utilize this information along with a particular communication protocol to converse electronically. The present invention can employ a user's provided IP address and port number to communicate caller information. This is advantageous at least in that information can be sent and received without much, if any, interference from user network firewalls.

Call processing component 210 processes rules or preferences that are specified by a called party (also referred to herein as the client). Call preferences define the conditions and action to be taken, if any, upon receipt of a call. For example, if the caller is Sean and I am in a meeting then generate a message indicating to Sean that I am in a meeting and I will call him back after the meeting is through. Alternatively, if the caller is John then a preference can be provided that immediately forwards the call to the most accessible client device at the time of the call. To facilitate execution of preferences data store 220 can be utilized. Data store 220 stores client information in an organized manner. Consequently, data store 220 can be easily searched so as to provide valuable client information that can be operated on. Data store 220 can include calendar application data, spreadsheet data, or any other data for that matter. Accordingly, call preferences could be designed to utilize calendar data, for example, to take some action if the calendar indicates a user or client is unavailable at the time a call is received.

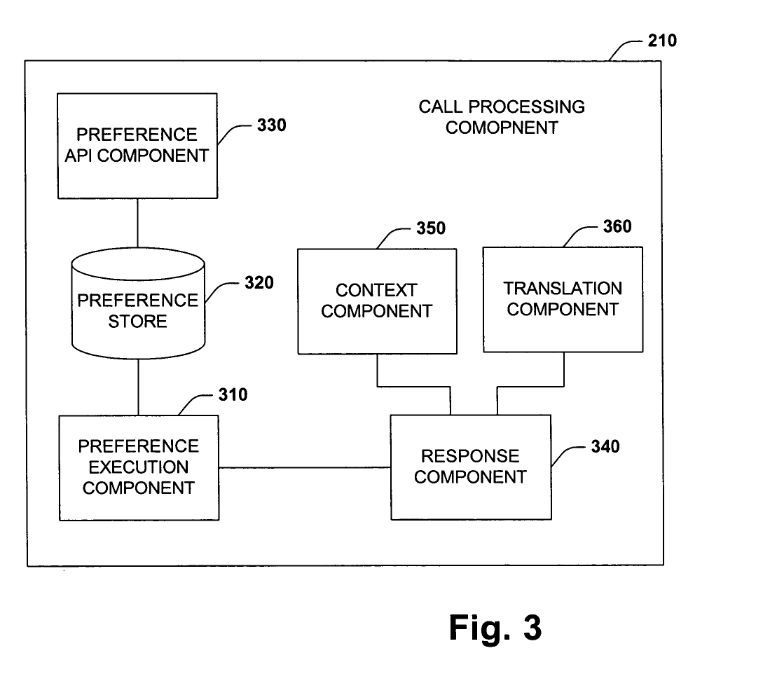

Turning to FIG. 3, the call processing component 210 of FIG. 2 is illustrated in further detail to illustrate various aspects of the present invention. As illustrated, the call processing component 210 includes preference execution component 310, preference store 320, preference application programming interface (API) 330, response component 340, a context component 350, and a translation component 360. Preference execution component 310 executes or validates client preferences or rules against available data. Preference store 320 acts as a preference repository and provides preferences to the preference execution component 310. Preference API 330 facilitates retrieval and storage of preferences in data store 320. Upon successful execution of a preference, response component 340 can be employed to provide an appropriate response. Response component 340 can, according to one aspect of the subject invention, generate a personalized message for playback to a caller. Such message can be a computer-generated message, a personalized voice message from the client, or a combination of the two. Additionally or alternatively, the response can notify the client that a particular call has been placed and received. Furthermore, according to one aspect of the invention, the response component 340 can employ a context component 350 to determine the best means of communicating such a notification. According to yet another aspect of the invention, the response component can forward the call to the called party. Furthermore, the response component 340 can utilize translation component 350 to translate message text from one language to another (e.g., English to German, French to Spanish, Italian to English . . . ).

Consider the following sample scenario presented for purposes of understanding various aspects of the subject invention. It should be noted that the following scenario is exemplary and not meant to limit of the scope of the present invention in any way. First, John adds Sean to a “Preferred Callers” group on his client device or system. Subsequently, John sets incoming call rules for the preferred caller group. Sean then calls John's number (e.g., 555-555-1234). On a preset number of rings (e.g., 3, 5 . . . ), Sean's call is picked up and Sean receives a voice message such as “Please wait . . . .” Alternatively, it should be appreciated that the caller, here Sean, could simply hear a simulated ring tone or other sounds rather than a voice message. While Sean is waiting, his caller information (e.g., phone number, name) is transferred to John's registered client device (e.g., personal computer, pocket pc, mobile IP device . . . ). The client device's call processing component recognizes from the caller information that the caller is Sean and that he is associated with the Johns previously defined preferred callers group and particular rule(s). Accordingly, the call processing component executes associated rule(s) or preference(s). For instance, the call processing component can examine John's busy/free calendar status and extract appointment data if busy along with the time John will be available. An appropriate message can then be constructed by appending strings, for example: “Hi” +first name+“I am in the following meeting:” + meeting name+ “I will call you back at” +meeting end time+“when I get out of this meeting.” The text message prompt can then be passed to the switch component or service provider and played back to Sean providing individualized information about John and the option for further call processing (e.g., forward to voice mail). Furthermore, it should be appreciated that the text strings can be converted to an audible speech message prior to sending the message to the switch component.

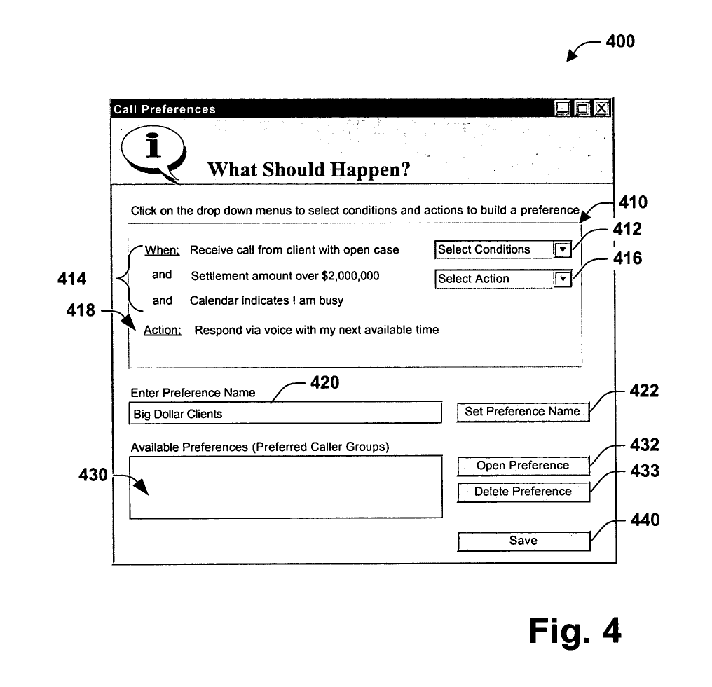

Preferences or rules can be stored locally in preference store 320. To populate preference store 320 with rules preference API 330 and a user interface can be employed. Turning to FIG. 4, an exemplary graphical user interface 400 is illustrated in accordance with an aspect of the subject invention. Graphical user interface 400 can collaborate with API 330 (FIG. 3) to generated and subsequently store client call preferences. Box 410 contains the preference specification components such as condition drop down menu 412 and action drop down menu 416. Condition drop down menu 412 can be used to select amongst a plurality of condition templates that can be utilized to facilitate specification of complete conditions 414. As illustrated, conditions 414 state that an action should be taken when (1) a call is received from a client with an open case, (2) the settlement amount is over $2,000,000, and (3) the client's calendar indicates that they are busy. Action drop down menu 416, similar to condition drop down menu 414, can be utilized to select amongst a multitude of action templates that can, if necessary, be modified by a client to produce one or more actions 418. Here, action 418 corresponds to responding to a caller via voice indicating that next time available. A client can subsequently specify a preference name or preferred caller group name by typing it into text box 420. Here, the name is “Big Dollar Clients.” Thereafter, button 422 can be activated to set the preferred caller group name. The name can then appear in text box 430 as an available preference (not shown). Buttons 432 and 433 can be utilized to open a selected preference or delete a selected a preference (e.g., utilizing a pointing device such as a mouse, trackball, stylus, touchpad . . . ), respectively. Finally, after adding a preference and/or modifying others button 440 can be utilized to initiate a save process, wherein the preferences are saved to preference store 320 (FIG. 3). In accordance with the newly specified preference, if a lawyer's client, Dan, calls who has an open case with a projected settlement amount over $2,000,000, and the lawyer's calendar indicates that the lawyer is busy, then a customized message can be provided such as “Hi Dan, I am unavailable right now, but I will call you back at 1 p.m.” It should be appreciated that the graphical user interface 400 and the values specified therein are merely exemplary and are not meant to limit the scope of the invention in any way. It will also be appreciated by those of skill in the art that many variations on the above preference can exist. For example, the actions could have been to set a meeting, or if the client is important enough notify the lawyer of his call and/or forward the call to an available communication device such as a mobile phone or conference room phone.

As has been described thus far, preferences can be stored locally on a user device or computer system. However, according to another aspect of the invention some or all preferences information can be stored or cached in a service provider data store 112 (FIG. 1), for example. Thus, there can be both client side and business or service side rules that can be executed concurrently or separately to provide a rapid response to a calling party. For instance, response messages can be recorded and saved in a service provider data store 112 such that messages can quickly be constructed and replayed to a caller. Furthermore, rules stored in a service provider data store 112 can be utilized in the unfortunate event that the client device or computer system cannot be contacted to respond to an incoming call.

Turning back to FIG. 3, preference execution engine 310 executes preferences stored in preference store 320. In particular, preference engine 310 retrieves or receives one or more preferences from preference store 320 based on an incoming call. Upon receipt of a call and identification of a caller, the preference engine can search through the preference store to locate a corresponding rule if in fact one has been defined. Accordingly, if Bill calls, preference engine locates Bill or a group in which Bill has been associated and retrieves the associated preference(s). The preference(s) can then be executed and a response or action generated. The response can include but is not limited to generating a personalized message, forwarding the call to voice mail, forwarding the call to another number, and/or notifying the called party. Response component 340 provides further customization of a generated response including but not limited to translating a message utilizing translation component 360 and determining a client context to provide effective notification in accordance with a preference employing context component 350.

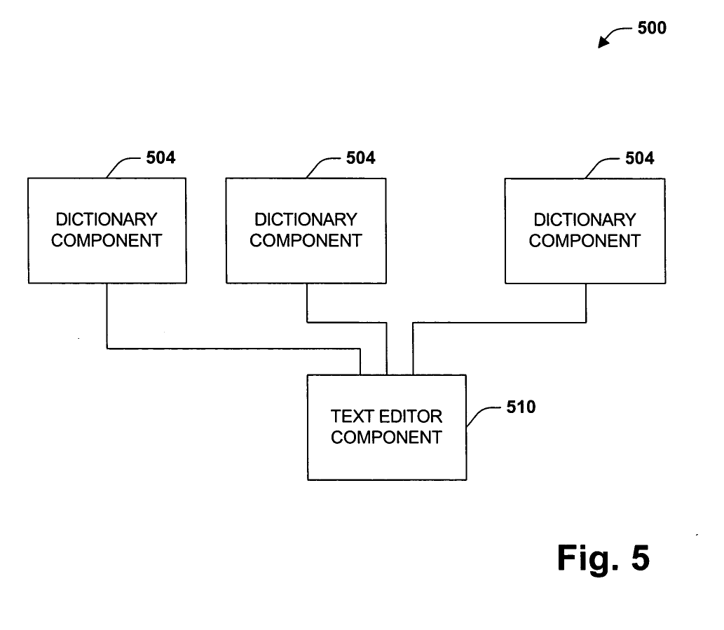

Turning to FIG. 5, a system for translating messages 500 is depicted in accordance with an aspect of the subject invention. System 500 can be employed by translation component 360 (FIG. 3) to produce accurate message translations. Preferences can be established which also identify not only the message to be delivered to a caller but also the language in which to communicate the message. This allows a user to provide a personal message to callers in the language they are most comfortable using. However, the system of the subject invention can also utilize the translation system to translate all messages to facilitate use worldwide while maintaining a system base language (e.g., English). System 500 comprises a text editor component 510 a multitude of dictionary components 504. Text editor component 510 can receive a message in the base language or the system, for example, “I am in a meeting now. I will call you back at 4 p.m. when I get out.” Dictionary components 504 provide particular translations. For example, one dictionary component can provide translation from English to Spanish another can provide English to French, another Spanish to English and so forth. Text editor component 510 can utilize one or more of the dictionary components 504 to generate a translated message, for example by parsing the message, looking up, and cross referencing words in dictionary components 504.

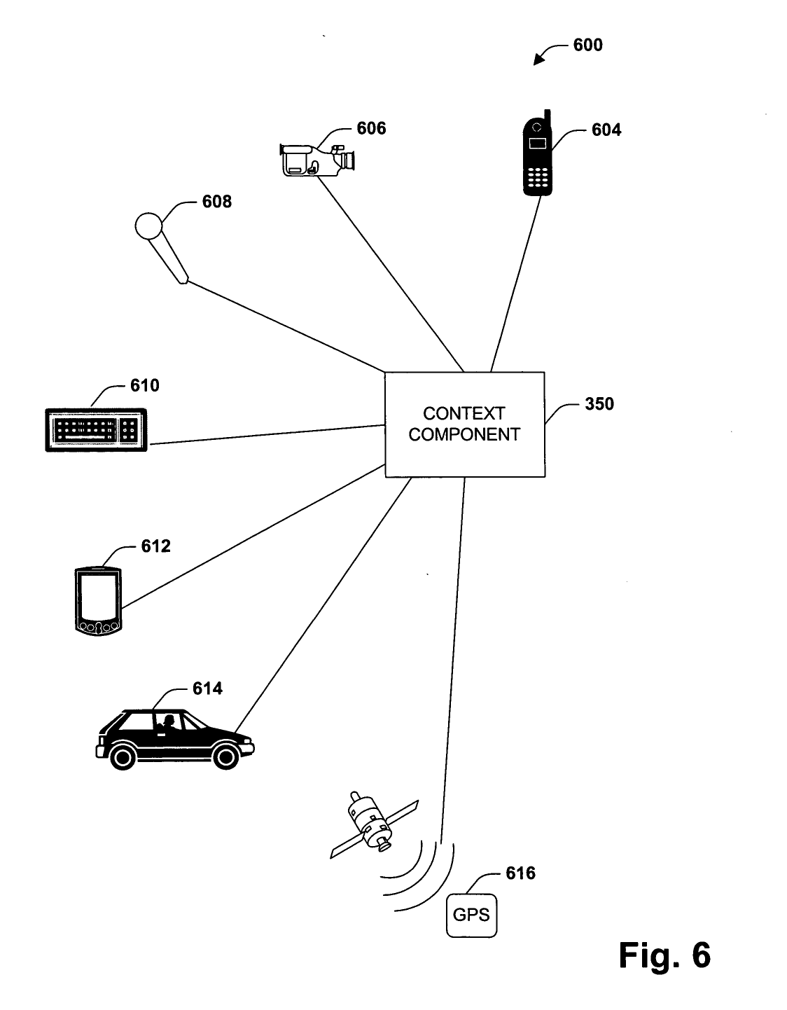

According to an aspect of the present invention, a client (a.k.a. called party, subscriber) can be provided with notification of a particular call in accordance with a specified preference. Furthermore, a client can set a rule (or set of rules) which indicates that a call from particular individual(s) (e.g., boss, biggest client . . . ) should be forwarded to a client device (e.g., mobile phone). In both cases there are at least two options. The client can be required to specifically specify which one a plurality of devices to notify or forward a call to at particular times. Alternatively, a client's context can be determined by direct measurement, for example, using one or more sensors as illustrated in accordance with an aspect of the present invention (FIG. 6). The context of the user can include the user's attentional focus, as well as his or her current location. The invention itself is not so limited, however. Direct measurement of context indicates that sensor(s) can be employed to detect whether the user is currently amenable to receiving alerts or notifications, and to detect where the client is currently located. According to one aspect of the present invention, an inferential analysis in conjunction with direct measurement can be utilized to determine user context.

Referring to FIG. 6, a system 600 in which direct measurement of client/user context can be achieved is illustrated. The system 600 includes a context component 350 (also referred to herein as a context analyzer) communicatively coupled to a number of sensors 604-616, namely, a cell phone 604, a video camera 606, a microphone 608, a keyboard 610, a PDA 612, a vehicle 614, and a GPS 616, for example. The sensors 604-616 depicted in FIG. 6 are for exemplary purposes only, and do not represent a limitation or a restriction on the invention itself. The term sensor as used herein is a general and overly encompassing term, meaning any device or manner by which the context analyzer component 350 can determine a user's current attentional focus, and/or a user's current location.

For example, if the user has the cell phone 604 on, this can indicate that the user can receive notifications on or calls forwarded to the cell phone 604. However, if the user is currently talking on the cell phone 604, this can indicate that the user has his or her attentional focus on something else (namely, a current phone call), such that the user should not presently be disturbed with a notification alert or a forwarded call. A video camera 606 can, for example, be in the user's office, to detect whether the user is in his or her office (viz., the user's location), and whether others are also in his or her office, suggesting a meeting with them, such that the user should not be disturbed (viz., the user's focus). Similarly, the microphone 608 can also be in the user's office, to detect whether the user is talking to someone else, such that the user should not be disturbed, is typing on the keyboard (e.g., via the sounds emanating therefrom), such that the user should also not be presently disturbed. The keyboard 610 can also be employed to determine if the user is currently typing thereon, such that, for example, if the user is typing very quickly, this may indicate that the user is focused on a computer-related activity, and should not be unduly disturbed (and, also can indicate that the user is in fact in his or her office). Accordingly, notification can be via instant message or email for example.

If the PDA device 612 is being accessed by the user, this can indicate that the user is able to receive alerts at the device 612—that is, the location at which notifications should be conveyed is wherever the device 612 is located. The device 612 can also be utilized to determine the user's current attentional focus. The vehicle 614 can be utilized to determine whether the user is currently in the vehicle—that is, if the vehicle is currently being operated by the user. Furthermore, the speed of the vehicle can be considered, for example, to determine what the user's focus is. If the speed is greater than a predetermined speed, for instance, then it may be determined that the user is focused on driving, and should not be bothered with notification alerts. GPS device 616 can also be employed to ascertain the user's current location, as known within the art.

In the following section of the detailed description, a determination of user context according to user-modifiable rules is described. The context of the user can include the user's attentional focus, as well as his or her current location. The invention is not so limited, however. Determining context via rules indicates that a hierarchical set of if-then rules can be followed to determine the user's location and/or attentional focus.

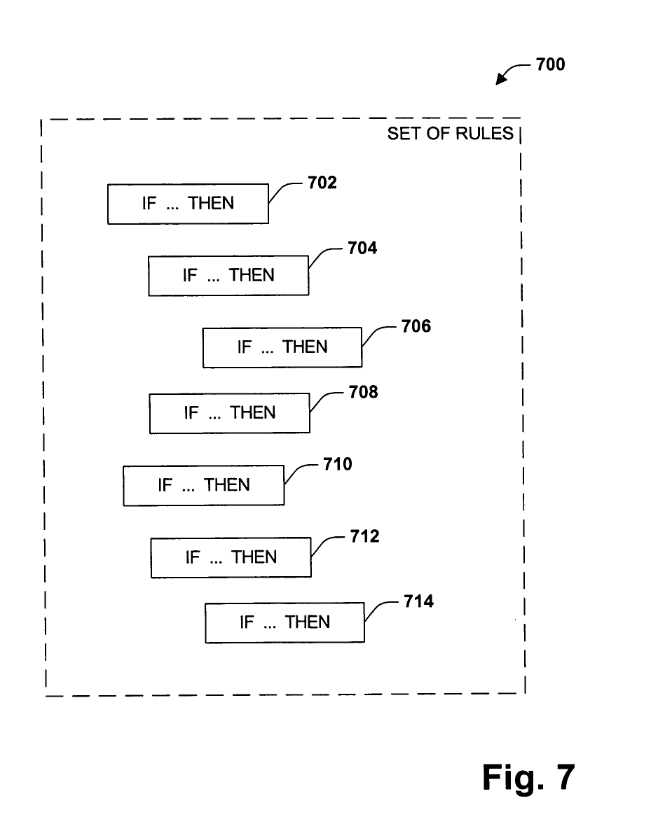

Referring to FIG. 7, a diagram illustrates an exemplary hierarchical ordered set of rules 700. The set of rules 700 depicts rules 702, 704, 706, 708, 710, 712 and 714, for example. It is noted that other rules may be similarly configured. As illustrated in FIG. 7, rules 704 and 706 are subordinate to 702, while rule 706 is subordinate to rule 704, and rule 714 is subordinate to rule 712. The rules are ordered in that rule 602 is first tested; if found true, then rule 704 is tested, and if rule 704 is found true, then rule 706 is tested, and so forth. If rule 704 is found false, then rule 708 is tested. If rule 702 is found false, then rule 710 is tested, which if found true, causes testing of rule 712, which if found true causes testing of rule 714. The rules are desirably user creatable and/or modifiable. Otherwise-type rules can also be included in the set of rules 600 (e.g., where if an if-then rule is found false, then the otherwise rule is controlling).

Thus, a set of rules or preferences can be constructed by the user such that the user's context is determined. For example, with respect to location, the set of rules can be such that a first rule tests whether the current day is a weekday. If it is, then a second rule subordinate to the first rule tests whether the current time is between 9 a.m. and 5 p.m. If it is, then the second rule indicates that the user is located in his or her office; otherwise the user is at home. If the first rule is found to be false—that is, the current day is a weekend and not a weekday—then an otherwise rule may state that the user is at home. It is noted that this example is not meant to be a restrictive or limiting example on the invention itself, wherein one or more other rules may also be similarly configured.

Furthermore, it should be appreciated that a user's context can be determined by inferential analysis, such as by employing a statistical and/or Bayesian model. It should further be noted that context determination via inferential analysis can rely in some aspects on other determinations, such as direct measurement via sensor(s), as has been described. Inferential analysis as used herein refers to using an inference process(es) on a number of input variables, to yield an output variable(s), namely, the current context of the user. The analysis can include in one aspect utilization of a statistical model and/or a Bayesian model.

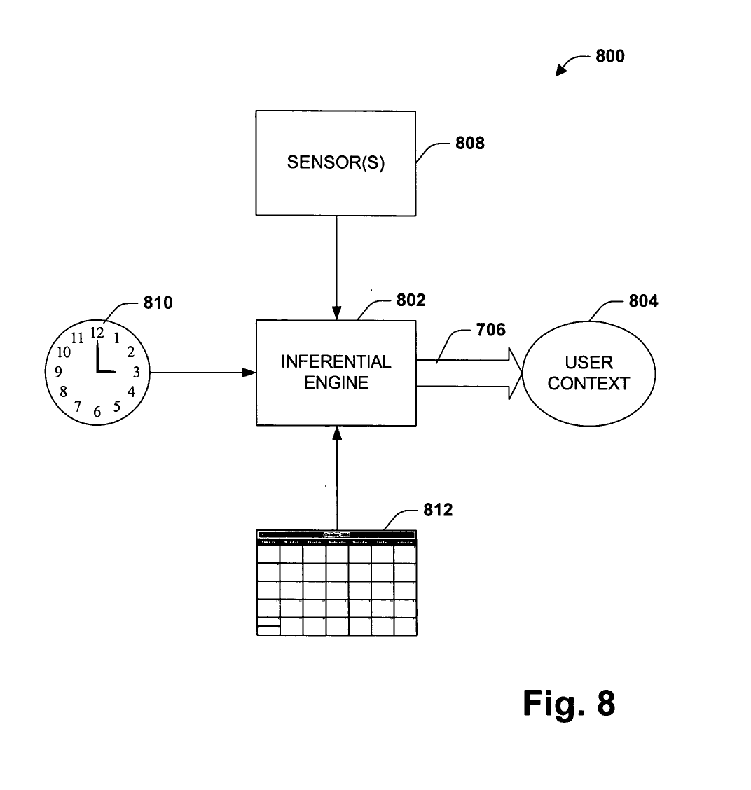

Referring to FIG. 8, a diagram of a system 800 is illustrated in which inferential analysis is performed by an inferential engine 802 to determine a user's context 804, according to an aspect of the present invention. The engine 802 is in one aspect a computer program executed by a processor of a computer from a computer-readable medium thereof, such as a memory. The user context 804 can be considered the output variable of the engine 802

The engine 802 can process one or more input variables to make a context decision. Such input variables can include one or more sensor(s) 808, such as the sensor(s) that have been described in conjunction with a direct measurement approach for context determination in a previous section of the description, as well as the current time and day, as represented by a clock 810, and a calendar 812, as may be accessed in a user's scheduling or personal-information manager (PIM) computer program, and/or on the user's PDA device, for example. Other input variables can also be considered besides those illustrated in FIG. 8. Furthermore, it should be appreciated that the variables of FIG. 8 are not meant to be a limitation or a restriction on the invention itself.

Turning briefly back to FIG. 3, it should be appreciated that after response component 340 received context information from context component 350 or translated message(s) from translation component 360, such response information can be transmitted directly to the client from the client computer system and/or back to the switch component 112 (FIG. 1). For instance, response component could provide the message in a base language or a translated language to the switch to be played back to a caller, while notifications could be sent utilizing a client's computer system alone or in combination with some web service, for example. To further appreciated aspects of the subject invention the following section describes one or several manners or scenarios in which the present invention can be utilized.

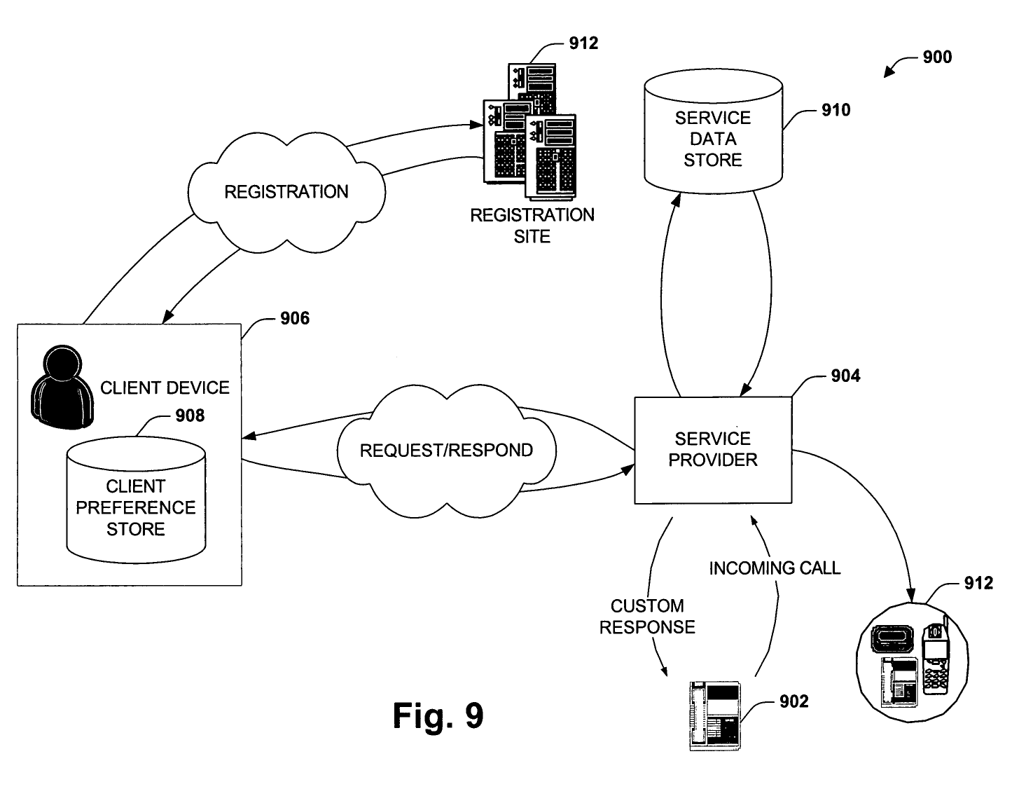

Turning to FIG. 9, an exemplary system 900 is depicted to facilitate an understanding of several aspects of the present invention. A telephonic device 902 (e.g., land line telephone, mobile phone, Internet phone) can be utilized by an individual or entity to contact and communicate with another individual or entity. The incoming call from the telephonic device 902 can be received by a service provider 904. The service provider 904 can be a telephone company or any other provider of telephone services. Upon receipt of an incoming call, the service provider 904 can park the call and request information from the client device 906 (e.g., a personal computer) and/or receive information from the service data store 910. Client device 906 can communicate with registration site 912 to register for dynamic call processing. Once registered and approved, the client device can respond to requests from the service provider 904. Requests from and responses to the service provider can be provided utilizing a Simple Object Access Protocol (SOAP), according to one aspect of the subject invention, which is a platform independent XML based protocol. For instance, the following sample SOAP request and response can be utilized to alert and request processing instructions from a client device for an incoming call. Of course, the bold face place holders would be replaced by data values in an actual implementation thereof.

```
POST /AlertsService/Message.asmx HTTP/1.1
Host: alerts.telws.net
Content-Type: text/xml; charset=utf-8
Content-Length: length
SOAPAction:
“http://mycompany.net/alerts/websvcs/message/2003/04/01/IncomingCall”
<?xml version=“1.0” encoding=“utf-8”?>
<soap:Envelope xmlns:xsi=“http://www.w3.org/2001/XMLSchema-
instance”
xmlns:xsd=“http://www.w3.org/2001/XMLSchema”
xmlns:soap=“http://schemas.xmlsoap.org/soap/envelope/”>
  <soap:Body>
    <IncomingCall
xmlns=“http://mycompany.net/alerts/websvcs/message/2003/04/01/”>
      <callId>string</callId>
      <accountId>string</accountId>
      <callerId>string</callerId>
      <switchUri>string</switchUri>
      <switchData>string</switchData>
      <callState>PreRouteCall or PostRouteCallFailure or
PostRouteCallSuccess or PreVoicemail or PostVoicemailFailure or
PostVoicemailsuccess or Unknown</callState>
      <callActionUrl>string</callActionUrl>
    </IncomingCall>
  </soap:Body>
</soap:Envelope>
HTTP/1.1 200 OK
Content-Type: text/xml; charset=utf-8
Content-Length: length
<?xml version=“1.0” encoding=“utf-8”?>
<soap:Envelope xmlns:xsi=“http://www.w3.org/2001/XMLSchema-
instance”
xmlns:xsd=“http://www.w3.org/2001/XMLSchema”
xmlns:soap=“http://schemas.xmlsoap.org/soap/envelope/”>
  <soap:Body>
    <IncomingCallResponse
xmlns=“http://mycompany.net/alerts/websvcs/message/2003/04/01/” />
  </soap:Body>
</soap:Envelope>
```

The client device can generate a response to a request for processing instructions utilizing preference rules stored locally in a client preference store 908 and provided call information (e.g. caller id number). The client device can then inform the service provider 904 of the proper response to the parked call. The proper response can include but is not limited to a message generated by the client device, instructions to retrieve pre-stored or pre-recorded responses (e.g., “I am in a meeting all day,” “I am out of the office all day”) from service data store 910, and/or provide notification to the client subscriber. The service provider 904 receives and/or retrieves the proper response information from the client device 906 or service data store 910 and provides a response to the telephonic device 902 and optionally notification to client subscriber device(s) 912 (e.g., pager, PDA, mobile phone, office phone, car phone, email, instant message . . . ).

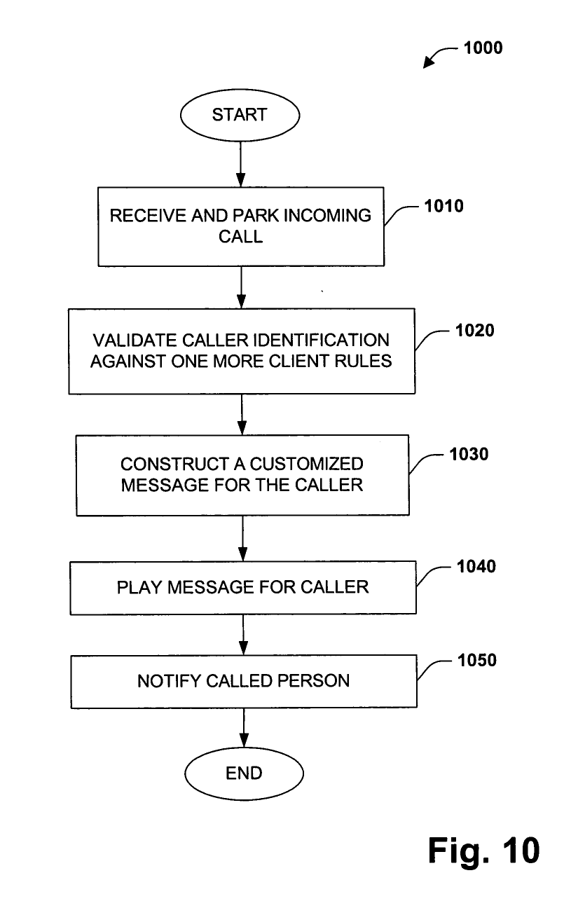

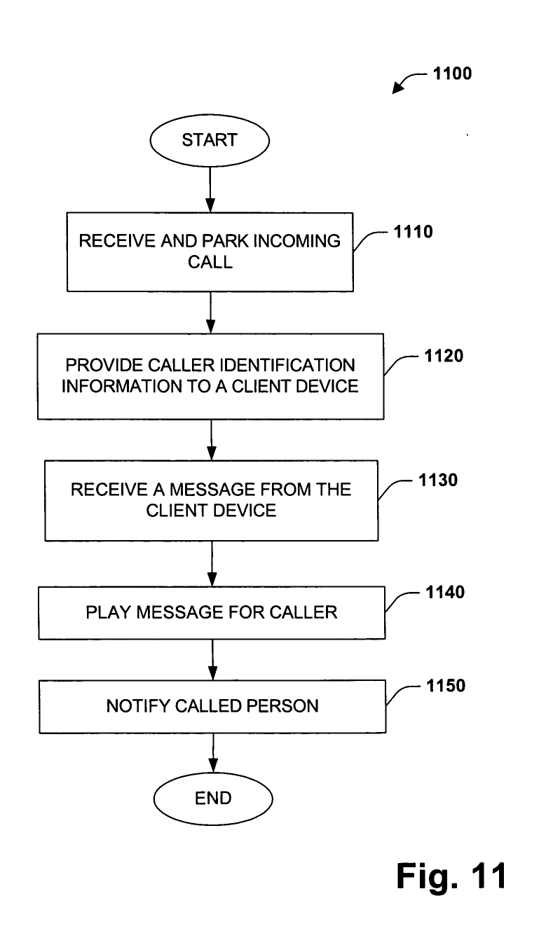

In view of the exemplary system(s) described supra, a methodology that may be implemented in accordance with the present invention will be better appreciated with reference to the flow charts of FIGS. 10-11 . While for purposes of simplicity of explanation, the methodology is shown and described as a series of blocks, it is to be understood and appreciated that the present invention is not limited by the order of the blocks, as some blocks may, in accordance with the present invention, occur in different orders and/or concurrently with other blocks from what is depicted and described herein. Moreover, not all illustrated blocks may be required to implement the methodology in accordance with the present invention.

Additionally, it should be further appreciated that the methodologies disclosed hereinafter and throughout this specification are capable of being stored on an article of manufacture to facilitate transporting and transferring such methodologies to computers. The term article of manufacture, as used, is intended to encompass a computer program accessible from any computer-readable device, carrier, or media.

FIG. 10 is a flow chart diagram of a call processing methodology 1000 in accordance with an aspect of the subject invention. At 1010, a call is received, for instance from a telephone company switch. Thereafter the call is parked to allow sufficient time to process the call. A caller can be notified once the call is parked, for example “Please wait. Your call is currently being processed.” Alternatively, a simulated ring tone can be utilized while the call is being processed. Subsequently, caller identification information is received or retrieved and at 1020 caller identification is validated against one or more client rules or preferences. In other words, callers are matched to specific preferences, for instance, stored or cached in a service provider store. Callers can be matched specifically or as part of a group or class of callers. For example, if a preference specifies a particular response for a big client and that big client calls then the preference condition has been met. At 1030, customized messages can be constructed for a caller based on a rule associated with the caller or a rule associated with the group of which the caller is a member. Subsequently, the constructed or generated message can be played for the caller at 1040. Optionally, at 1050, notification can be provided to the called person, entity, or party based on a preference specifying if, when, and for whom to generate a notification. If a called person is to be notified they can be notified as specifically specified by a preference (e.g., particular device). Alternatively, a called person's context can be examined and a notification sent to the most appropriate notification device. Notification device can include but are not limited to pagers, personal digital assistants (PDAs), phones (e.g., mobile, home, office, car . . . ) and computers (e.g., instance message, email . . . ). Additionally, it should be appreciated that conventional call processing can also be employed together with the dynamic and customized call processing of the present invention. Accordingly, a caller could leave a voice message for the called person, for instance. Furthermore, calls could be forwarded to different client phone number in accordance with a preference, for example.

Turning to FIG. 11, a method for providing customized call responses is illustrated in accordance with an aspect of the subject invention. At 1110, a call an incoming call is received, for example, by a telephone company switch. Subsequently, the call is parked to allow adequate time for processing the call. Once the incoming call is received and parked a user message can be provided to the user such as “Please wait. Your call is being processed.” Alternatively, a simulated ring could be provided to the caller until call processing is complete. At 1120, caller identification information is provided to a client device. Caller ID information can be received or retrieved in a manner as is known in the art. A client device can be any computing device including but not limited to a personal computer (e.g., desktop, laptop, server . . . ), a television set top box and a gaming system or console. Caller identification information can be provided to a client device over any one or more of a plurality of media channels. According to one aspect of the invention, the communications can be provided via the instant messaging channel to facilitate communication without interference from consumer or company firewalls. The client device receives the caller information and processes such information along with other information and a set of rules or preferences, and ultimately produces a message such as “I am sorry I can't take your call. I am in a meeting right now. I will call you back later when I get out of the meeting.” At 1130, the generated message is received from the client device. Thereafter, the message can be played for the caller at 1140. Additionally or alternatively, the called party or person can be provided with notification of a call, at 1150. Notification can be provided based on preferences or rules that specify if, when, and from whom notifications will be generated. For example, notification could be specified for one or more big clients. Notification can be accomplished via any one or more of a number of devices including but not limited to pagers, phones (e.g., mobile, home, office, car), personal digital assistants (PDAs), and computers (e.g., email, instant message . . . ). Furthermore, it should be appreciated that further actions can be taken after a customized message is provided. For example, a caller can leave a voice message. Additionally, other conventional call processes are not mutually exclusive of the customized processing of the subject invention. Accordingly, a client could specify that rather than being notified of a receipt of a particularly important that the call processing system should forward the call to another phone number (e.g., mobile, home, car, office).

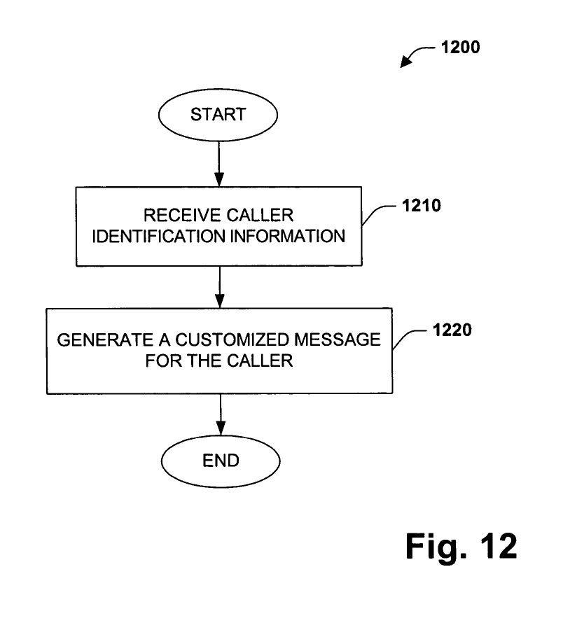

Turning to FIG. 12 a customized call processing methodology 1200 is depicted in accordance with an aspect of the present invention. At 1210, caller identification is received (e.g., caller name, phone number . . . ). For example, caller identification information can be provided by a telecommunication company. Caller identification information can be provided to a personal computer, for example, utilizing an instant messaging channel to avoid interference from firewalls. At 1220, a customized message is generated for the caller. The customized message is produced based on one or more preferences or rules specified with respect to a particular caller or group of callers. Accordingly, the customized message is at least a function of the particular caller. Furthermore, the customized message can be a function of the called person's status. For example, if ‘big client’ calls and I am in a meeting, generate a particular response, however if ‘big client’ calls and I am on vacation, then generate a different response. The called party's status can be determined utilizing stored application information. For instance and in accordance with one aspect of the invention, such application data can be from a calendar or scheduling program (e.g., Microsoft Outlook).

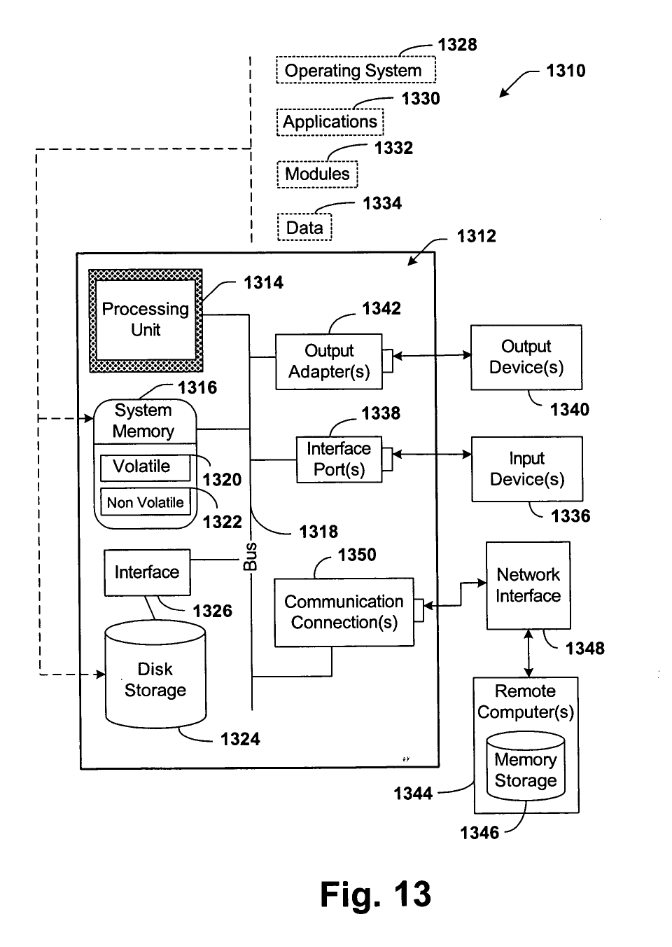

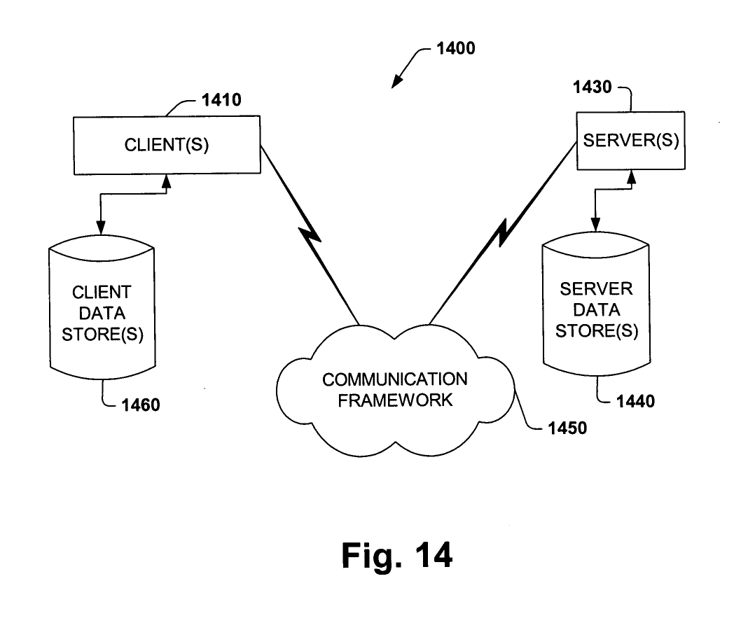

In order to provide a context for the various aspects of the invention, FIGS. 13-14 as well as the following discussion are intended to provide a brief, general description of a suitable computing environment in which the various aspects of the present invention may be implemented. While the invention has been described above in the general context of computer-executable instructions of a computer program that runs on a computer and/or computers, those skilled in the art will recognize that the invention also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices, microprocessor-based or programmable consumer electronics, and the like. The illustrated aspects of the invention may also be practiced in distributed computing environments where task are performed by remote processing devices that are linked through a communications network. However, some, if not all aspects of the invention can be practiced on stand-alone computers. In a distributed computing environment, program modules may be located in both local and remote memory storage devices.

With reference to FIG. 13, an exemplary environment 1310 for implementing various aspects of the invention includes a computer 1312. The computer 1312 includes a processing unit 1314, a system memory 1316, and a system bus 1318. The system bus 1318 couples system components including, but not limited to, the system memory 1316 to the processing unit 1314. The processing unit 1314 can be any of various available processors. Dual microprocessors and other multiprocessor architectures also can be employed as the processing unit 1314.

The system bus 1318 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1316 includes volatile memory 1320 and nonvolatile memory 1322. The basic input/output system (BIOS), containing the basic routines to transfer information between elements within the computer 1312, such as during start-up, is stored in nonvolatile memory 1322. By way of illustration, and not limitation, nonvolatile memory 1322 can include read only memory (ROM), programmable ROM (PROM), electrically programmable ROM (EPROM), electrically erasable ROM (EEPROM), or flash memory. Volatile memory 1320 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM(DRRAM).

Computer 1312 also includes removable/non-removable, volatile/non-volatile computer storage media. FIG. 13 illustrates, for example disk storage 1324. Disk storage 4124 includes, but is not limited to, devices like a magnetic disk drive, floppy disk drive, tape drive, Jaz drive, Zip drive, LS-100 drive, flash memory card, or memory stick. In addition, disk storage 1324 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1324 to the system bus 1318, a removable or non-removable interface is typically used such as interface 1326.

It is to be appreciated that FIG. 13 describes software that acts as an intermediary between users and the basic computer resources described in suitable operating environment 1310. Such software includes an operating system 1328. Operating system 1328, which can be stored on disk storage 1324, acts to control and allocate resources of the computer system 1312. System applications 1330 take advantage of the management of resources by operating system 1328 through program modules 1332 and program data 1334 stored either in system memory 1316 or on disk storage 1324. Furthermore, it is to be appreciated that the present invention can be implemented with various operating systems or combinations of operating systems.

A user enters commands or information into the computer 1312 through input device(s) 1336. Input devices 1336 include, but are not limited to, a pointing device such as a mouse, trackball, stylus, touch pad, touch screen, keyboard, microphone, joystick, game pad, satellite dish, scanner, TV tuner card, digital camera, digital video camera, web camera, and the like. These and other input devices connect to the processing unit 1314 through the system bus 1318 via interface port(s) 1338. Interface port(s) 1338 include, for example, a serial port, a parallel port, a game port, and a universal serial bus (USB). Output device(s) 1340 use some of the same type of ports as input device(s) 1336. Thus, for example, a USB port may be used to provide input to computer 1312 and to output information from computer 1312 to an output device 1340. Output adapter 1342 is provided to illustrate that there are some output devices 1340 like monitors, speakers, and printers, among other output devices 1340 that require special adapters. The output adapters 1342 include, by way of illustration and not limitation, video and sound cards that provide a means of connection between the output device 1340 and the system bus 1318. It should be noted that other devices and/or systems of devices provide both input and output capabilities such as remote computer(s) 1344.

Computer 1312 can operate in a networked environment using logical connections to one or more remote computers, such as remote computer(s) 1344. The remote computer(s) 1344 can be a personal computer, a server, a router, a network PC, a workstation, a microprocessor based appliance, a peer device or other common network node and the like, and typically includes many or all of the elements described relative to computer 1312. For purposes of brevity, only a memory storage device 1346 is illustrated with remote computer(s) 1344. Remote computer(s) 1344 is logically connected to computer 1312 through a network interface 1348 and then physically connected via communication connection 1350. Network interface 1348 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1350 refers to the hardware/software employed to connect the network interface 1348 to the bus 1318. While communication connection 1350 is shown for illustrative clarity inside computer 1312, it can also be external to computer 1312. The hardware/software necessary for connection to the network interface 1348 includes, for exemplary purposes only, internal and external technologies such as, modems including regular telephone grade modems, cable modems and DSL modems, power modems, ISDN adapters, and Ethernet cards.

FIG. 14 is a schematic block diagram of a sample-computing environment 1400 with which the present invention can interact. The system 1400 includes one or more client(s) 1410. The client(s) 1410 can be hardware and/or software (e.g., threads, processes, computing devices). The system 1400 also includes one or more server(s) 1430. The server(s) 1430 can also be hardware and/or software (e.g., threads, processes, computing devices). The servers 1430 can house threads to perform transformations by employing the present invention, for example. One possible communication between a client 1410 and a server 1430 may be in the form of a data packet adapted to be transmitted between two or more computer processes. The system 1000 includes a communication framework 1450 that can be employed to facilitate communications between the client(s) 1410 and the server(s) 1430. The client(s) 1410 are operably connected to one or more client data store(s) 1460 that can be employed to store information local to the client(s) 1410. Similarly, the server(s) 1430 are operably connected to one or more server data store(s) 1440 that can be employed to store information local to the servers 1430.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes or having” is used in either the detailed description or the claims, such term is intended to be inclusive in a manner similar to the term “comprising” as “comprising” is interpreted when employed as a transitional word in a claim.

1. A call processing system comprising:
a switch component to receive incoming telephone calls; and
a client computer system that receives data from the switch component regarding caller identity and generates a customized response in accordance with user defined rules or preferences.

2. The system of claim 1, the computer system comprising a call processing component that generates a message to be played to a caller.

3. The system of claim 2, the call processing component comprising a preference store for housing user defined rules.

4. The system of claim 3, further comprising a preference application programming interface component adapted to receive one or more preferences and store them in the preference store.

5. The system of claim 2, further comprising a preference execution component adapted to receive and/or retrieve preferences from the preference store and generate a response to an incoming call.

6. The system of claim 2, further comprising a translation component adapted to translate a message from a first language to a second language.

7. The system of claim 2, wherein the call processing component provides for a client subscriber to be notified.

8. The system of claim 7, further comprising a context component that determines client context to facilitate selection of an appropriate notification device and means of notification.

9. The system of claim 8, the notification device including one of a mobile phone, a pager, a personal computer and a personal digital assistant.

10. The system of claim 1, wherein the preferences define responses based on a client's status at a given time as specified in a calendar application.

11. The system of claim 1, wherein the client computer system is a personal computer.

12. The system of claim 1, wherein the client computer system is a television set-top box.

13. The system of claim 1, wherein the client computer system is a gaming console.

14. A dynamic call processing system comprising:
a means for receiving incoming calls;
a means for providing a client device information about a caller; and
a means for dynamically constructing a message for the caller based at least in part on client specified rules.

15. The system of claim 14, further comprising a means of playing the constructed message to the caller.

16. The system of claim 14, further comprising a means for notifying a client subscriber of a phone call.

17. A method of call processing comprising:
receiving an incoming call;
validating the caller against one or more client rules; and
constructing a customized message for the caller.

18. The method of claim 17, further comprising playing the message to the caller.

19. The method of claim 17, wherein the call is parked after it is received to provide sufficient time for message construction.

20. The method of claim 19, wherein a ring tone is simulated while the call is parked.

21. The method of claim 19, wherein an audio message asks the caller to hold while the call is processed.

22. The method of claim 17, further comprising notifying a called person of a call.

23. A computer readable medium having stored thereon computer executable instructions for carrying out the method of claim 17.

24. A method for providing customized call responses comprising:
receiving an incoming telephone call from a caller;
providing a client device caller identification information;
receiving a message from the client device; and
playing the message for the caller.

25. The method of claim 24, wherein the call is received utilizing a telecommunication switch.

26. The method of claim 24, further comprising parking the call after receiving it to provide sufficient time to receive a message from the client device.

27. The method of claim 26, wherein parking a call includes simulating a ring tone.

28. The method of claim 26, wherein parking a call include asking a caller to hold while the call is processed.

29. The method of claim 24, wherein the client device applies client preferences to generate customized messages for each caller or group of callers.

30. The method of claim 24, further comprising notifying a client subscriber of call.

31. A computer readable medium having stored thereon computer executable instructions for carrying out the method of claim 24.

32. A customized call processing methodology comprising:
receiving caller identification information; and
generating a customized message, wherein the message is a function of particular caller and a specified client rule.

33. The method of claim 32, wherein the caller identification information is received from a telecommunication company.

34. The method of claim 32, wherein the caller identification information is received via an instant messaging channel, thereby avoiding interference from firewalls.

35. The method of claim 32, wherein the customized message is a function of the called party's status.

36. The method of claim 35, the called party's status is determined utilizing data associated with one or more software applications stored on the party's computing device.

37. The method of claim 36, wherein the application is a calendar or scheduling application.

38. A computer readable medium having stored thereon computer executable instructions for carrying out the method of claim 32.
